(19) United States
(12) Patent Application Publication
(10) Pub. No.: US 2022/0006272 A1
(43) Pub. Date: Jan. 6, 2022

(54) 12/18VCT-Vertical Cable Tray

(71) Applicant: DECEBAL BUGARIU, MCALLEN, TX (US)

(72) Inventor: DECEBAL BUGARIU, MCALLEN, TX (US)

(21) Appl. No.: 16/920,714

(22) Filed: Jul. 5, 2020

(51) Int. Cl. H02G 3/04; F16L 3/26

(52) U.S. Cl. CPC H02G 3/0456; F16L 3/26

(57) ABSTRACT

Based on the embodiment structure shape and vertical position installation of 12/18VCT tray there are very remarkable advantages for supporting more cables, copper conductor savings and perfect application for retrofit and new projects, compared to traditional, ladder or ventilated, 12/18HCT tray, as described under CLAIMS section.

12/18VCT tray has improved embodiment structure shape and has been described for a preferred embodiment design of invention, compared to 12/18HCT tray. It will be understood that the design is capable of further modifications therefore, 12/18VCT tray is intended for comparison to any variations, uses or adaptations, following the principle of heat transfer theory, Newton's Law of Cooling Formula and N.E.C., Chapters 310 and 392, for cables and cable trays.

The invention includes all parts from the disclosures, as come within known or customary practice, in the art to which invention pertains and falls, within the limits of the appended claims.

### CROSS-REFERENCES TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

References submitted to the filing system (EFS-WEB) for the invention are as follows:

N.E.C., Table 310.15(6)(16) Allowable Ampacities of Insulated Conductors Rated up to and 2000 V, 60° C. through 90° C., Not More Than Three Current-Carrying Conductors in Raceway, Cable, or Earth, in Free Air Based on Ambient Air Temperature of 90° C. (Ref. 1).

### N.E.C., Table 392.22(A), Column 1—Allowable Cable Fill Area Surface for Multiconductor Cables in and Ventilated Trough Cable Tray for Cables Rated 2000 Volts or Less. (Ref. 2).

N.E.C., Art. 392.22(1)(a)—Cable Trays Containing All of Cables 4/0 AWG or larger. (Ref. 3)

### N.E.C., Chapter 9, Table 8—Conductor Properties. (Ref. 4)

Additional references submitted to the filing system (EFS-WEB) for the invention, are as follows:

### Cable Tray Selection, (Ref. 5)

### B-Line Strut Systems, (Ref. 6)

EngineeringToolBox.com—Convective Heat Transfer and Newton's Law of Cooling Formula, (Ref. 7)

### Quick-Field Simulation Software-Natural Convection Coefficient Calculator, (Ref. 8)

### STATEMENT REGARDING PRIOR DISCLOSURES BY THE INVENTOR OR A JOINT INVENTOR

Not Applicable

### BACKGROUND OF THE INVENTION

### Field of Invention

The invention refers to the cable tray system and in particular to the new vertical cable tray, named by inventor herewith 12/18VCT tray that will be used for the same purpose as the traditional, ladder or ventilated, horizontal cable tray named by inventor herewith 12/18HCT tray, to support electrical, control and communication cables for industrial and commercial facilities. The new invented 12/18VCT tray is built with a vertical embodiment structure shape in comparison to 12/18HCT traditional, ladder or ventilated cable tray, well already known in the market, which has a horizontal embodiment structure shape. 12/18VCT tray vertical embodiment structure will be at 90 degree, to the field supports, compared to 12/18HCT tray embodiment structure that will be flat at 0 degree to the field supports. Both cable trays, 12/18VCT and 12/18HCT, could be installed in the field in horizontal paths or vertical paths (risers), based on requirements of applications. In order to eliminate any confusion regarding two height dimensions of 12 inches and 18 inches, the height of vertical sides of 12/18VCT tray will be considered 18 inches. For correct comparison the width of 12/18HCT tray will be 18 inches, as well. However, the new invented 12/18VCT tray embodiment structure could be built with vertical heights starting from 12 inches up to 18 inches.

The principle concept of the invention of 12/18VCT tray is based on the buoyancy forces of air generated in the boundary layer near the surface areas of a heated flat plate body. Due to density differences, caused by temperature difference between heated flat plate body at higher temperature of 75° C. and the surrounding ambient air at lower temperature of 30° C., a significant heat transfer from heated flat plate body to the surrounding ambient air is created, known as natural convection. The natural convection changes the air density causing the heated surrounding ambient air to rise and be replaced by cooler surrounding ambient air which will also heat and rise again cooling the surface areas of heated flat plate body.

The significant natural convection heat transfer to the surrounding ambient air will take place at each of two vertical side large surface areas of the heated flat plate body, if the heated body flat plate is set in vertical position, compared to the heated flat plate body set in horizontal position where the significant heat transfer will take place at only one large side surface area which is the top horizontal surface area of the heated flat plate body. 12/18VCT tray is considered to be equivalent to a heated flat plate body in vertical position and 12/18HCT tray is considered to be equivalent to a heated flat plate body in horizontal position. Both cable trays, 12/18VCT tray and 12/18HCT tray, are considered to support energized electrical cables.

### Description of the Related Art Including Information Disclosed Under 37 CFR 1.97 and 37 CFR 1.98

U.S. Pat. No. 10,128,642 B2, Foldable Cable Tray, Column 4, Line 30

### BRIEF SUMMARY OF THE INVENTION

Abbreviated Technical Terms:

Aa: Allowable Cable Fill Surface Area (in²)
Ac: Individual Cable Fill Surface Area (in²)
Ai: Increased Cable Fill Surface Area (in²)
At: Maximum Cable Fill Surface Area (in²)
Cl: Concentrated Load (lbs)

### Dc: Cable Diameter (in)

Di: Density of Ice (lbs/ft³)

### EA: Number of Each Part

### Gr: Grashof Number

Hc1: Natural Convection Heat Transfer Coefficient of one vertical side face of 12/18VCT tray (W/m²° C.)
Hc2: Natural Convection Heat Transfer Coefficient of the opposite vertical side face of 12/18VCT tray (W/m²° C.)
Hc3: Natural Convection Heat Transfer Coefficient of a horizontal top face of 12/18HCT tray (W/m²° C.)
Ht: Height of Space for Cables Supported of 12/18VCT tray of 18 (in)
Hoverall: Overall Height of 12/18VCT tray of 19.89 (in)

### Ia: Allowable Cable Ampacity (Amps), per N.E.C.

### Ic: Individual Cable Ampacity, per N.E.C.

### Ii: Increased Cable Ampacity (Amps)

k: 1.29 multiplier representing the increase of heat transfer for 12/18VCT tray compared to 12/18HCT tray
\sqrt{k}: 1.14 multiplier representing the increase of cable ampacity Ia to Ii
Lc1: Electrical losses (W) of cable for current Ia
Lc2: Electrical losses (W) of cable for current Ii
Lt: Cable Tray Length (in) (ft) (m), considered for calculations
Li: Load Impact of Ice (lbs)
Ls: Load Impact of Snow (lbs)
Nc: Number of Cables supported by 12/18VCT tray or by 12/18HCT tray (EA)

### N.E.C.: National Electrical Code (Articles and Tables)

### Nu: Nusselt Number

Part 1: Vertical Side Channel 18 inch height
Part 2: Horizontal Across Base Channel—7.26 inches long
Part 3: Horizontal Long Base Channel—120 inches long
Part 4: Tray Splice—9 inches long

### Part 5: Angle Fitting R

### Part 6: Angle Fitting L

### Part 7: Two Hole Splice Plate

### Part 8: Cap Screw

### Part 9: Spring Nut

### Part 10: Tread Rod

### Part 11: Hex Nut

### Part 12: Flat Washer

### Part 13: End Cap

### Pg: Page

### Pr: Prandtl Number

### PU: Per Unit System

### Ra: Rayleigh Number

### Rc: DC Resistance of One Copper Cable Conductor (Ohm/kft) at 75° C.

### Ref: Reference

Qa: Actual heat transfer, for 12/18VCT tray or 12/18HCT tray, from surface area Aa of supported energized cables at 75° C. temperature, to surrounding ambient air at 30° C. temperature (W)
Qmax: Maximum heat transfer, for 12/18VCT tray or 12/18HCT tray, from surface area At of supported energized cables at 75° C. temperature, to surrounding ambient air at 30° C. temperature (W)

### Qty: Quantity of Parts

### Sd: Sum of Cable Diameters (in)

### Ss: Vertical Cable Tray Support Span (ft)

### t: Time (PU)

### Ta: Temperature of Surrounding Ambient Air (30° C.)

### Tc: Rated Temperature of Cable Conductors (75° C.)

### Ti: Thickness of Ice (in)

### V: Voltage (Volts)

### Wt: Width of 12/18HCT Cable Tray (in)

Wc: Weight of Cables (lbs/ft)
We: Concentrated Static Load, converted to Uniform Beam Load against Cable Tray (lbs/ft)
Wp: Wind Pressure (lbs/ft²)
Wv: Wind Velocity (mph)

### 3/C Cable: Three Copper Conductor Cable

### 3×(I²×R): Electrical Losses of Energized 3/C Cable (W)

12/18HCT tray: Name given by inventor to the existing traditional, ladder or ventilated, cable tray with two vertical sides of 4 inches high and one horizontal across width of 18 inches between the vertical sides.
12/18VCT tray: Name given by inventor to the new invented vertical cable tray with two vertical sides, of 18 inches high and one horizontal across width of 4 inches between the vertical sides.

Technical Statements:

Qmax calculations were executed by using Newton's Law of Cooling Formula: Qmax=Hc×At×(Tc−Ta). (Ref. 7)

Hc Coefficient of Newton's Law of Cooling Formula is calculated by using the Natural Convection Heat Transfer Coefficient Calculator software. (Ref. 8)

Use of B-Line or equal brand for channels, fittings, bolts, screws and nuts, as necessary, to build the 12/18VCT tray.

Torque for bolts and screws shall be 50 ft/lbs or higher. (Ref. 6, Pg. 44)

N.E.C. articles and tables for cable trays, cables and cable conductor properties, applied as required. (Ref. 1, 2, 3, 4)

Technical literature available for heat transfer to surrounding ambient air theory calculations, applied as required. (Ref. 5, 6, 7, 8)

Cable(s): Three copper conductors energized electrical cables, supported by either 12/18VCT tray or 12/18HCT tray. Cables should be suitable for cable tray applications. However, the invention refers only to energized three conductor electrical cables, supported by 12/18VCT tray or 12/18HCT tray.

Cables shall be considered engineered and designed correctly, per N.E.C., for cable tray applications.

Qmax and Qa transferred to surrounding ambient air are generated by copper conductor heat losses of energized cables, supported by 12/18VCT tray or 12/18HCT tray.

Assume that the insulation and sheath of cables have not influence to heat transfer from copper conductor losses. Therefore, the entire copper conductor heat losses will be transferred to the surrounding ambient air.

Cables rated temperature shall be considered 75° C. and the surrounding ambient air temperature shall be considered 30° C.

All cables supported, by either 12/18VCT tray or 12/18HCT tray shall have equal data regarding, resistance, ampacity, voltage, insulation type, length, diameter, circular area surface, weight, and group arrangement.

The cable type and size chosen are the most common used three conductor electrical cables for tray application in the market, as shown on Ref. 5, Pg. 16.

The group arrangements chosen for cables supported by 12/18VCT tray or 12/18HCT tray are as follows:

Group #1: From #8 AWG to #3/0 AWG cables. Cables of this group are vertically installed in 12/18VCT tray up to Aa or Ai and horizontally installed in the 12/18HCT tray up to surface area Aa.

Group #2: From #4/0 AWG to #750 kCMIL cables. Cables of this group are installed in 12/18VCT tray or 12/18HCT tray on a single vertical layer, having the sum of the cable diameters not exceeding 12/18VCT tray height or 12/18HCT tray width.

For calculations, the size of electrical cable chosen from each cable group arrangement is 3/C-#3/0 AWG from Group #1 and 3/C-#750 kCMIL from Group #2, respectively.

Rc of cables and time t are not changing their values for either 12/18VCT tray or 12/18HCT tray. Therefore, the values of Rc and t will be expressed in per unit system, Rc=1 PU and t=1 PU.

The calculation numbers, of 12/18VCT and 12/18HCT trays, are shown in decimal inches and the numerical results are rounded up on the second decimal if the third decimal is 5 or higher and rounded down if the third decimal is 4 or lower.

The most common materials used for fabrication of cable trays are galvanized steel, stainless steel, aluminum and fiberglass. The galvanized steel material is chosen for being stronger and allowing stronger vertical and horizontal external loads.

The use of B-Line channel B22 or an equal brand is chosen for embodiment structure of 12/18VCT tray. The beam uniform maximum loading capacities of B-Line channel B22 are for the following lengths:

2610 lbs/ft for 12 inches; 1702 lbs/ft for 24 inches; 340 lbs/ft for 120 inches

A space of 2 inch is set between two 12/18VCT trays, mounted on the same line, in order to accommodate the linear extension or contraction of trays due to surrounding ambient temperature changes. The splice chosen between two 12/18VCT trays, installed on the same row line, is B-Line channel BTS22TH of 9 inches long or an equal brand.

The beam uniform maximum loading capacities of BTS22TH is 4203 lbs/ft, for 12 inches length.

12/18VCT tray shall be installed in the field by using the traditional galvanized steel beam clamps and brackets, traditionally used for channels installation, as required per project applications (steel beams of buildings, T-poles of pipe bridges or walls of different facilities. After installation 12/18VCT trays shall be grounded and bonded, as required per N.E.C.

It is proven by calculations for Natural Convection Heat Transfer Coefficients, Hc1 and Hc2, that the total sum, Hc1+Hc2, of 12/18VCT tray is higher compared to the heat transfer coefficient Hc3 of the top horizontal surface area of 12/18HCT tray. Due to significant heat transfer for 12/18VCT tray, the cables supported will have a faster cooling process compared to the cables supported by 12/18HCT tray.

As a result, increased number of cables or increased ampacity of cables can be claimed as advantages of 12/18VCT tray, compared to 12/18HCT tray.

Due to its vertical embodiment structure shape and narrow overall width, the 12/18VCT tray is an excellent application for installations in existing or new crowded industrial or commercial facilities.

By setting the horizontal width of the cables supported space, between the vertical sides of 12/18VCT tray at 4 inches, all type and size of electrical cables, from Ref. 5, Pg. 16, could be installed in 12/18VCT tray.

Group #1 cables will fit into 4 inches space, grouping and spreading vertically into the 12/18VCT tray.

Group #2 cables must be arranged in one layer, filling 12/18VCt tray vertically. To achieve one layer arrangement, each cable of Group #2 shall be tied up to parts 1 of 12/18VCT tray, using traditional tight wires for cables, as required.

The calculations were executed, in order to prove the advantages claimed of increased number of cables or increased ampacity of cables, based on Newton's Law of Cooling Formula and N.E.C., articles 310 and 392, for cables and cable trays.

The calculations were executed only for those surface areas with significant heat transfer to the surrounding ambient air which are the two side vertical surface areas of 12/18VCT tray and only one top horizontal surface area of 12/18HCT tray.

For better understanding, the calculations were executed only for 12/18VCT tray with 18 inches height, to be compared to 12/18HCT tray with 18 inches width.

For clarity of calculations, the narrow horizontal surface areas at top and bottom of 12/18VCT tray and the horizontal surface area at bottom of 12/18HCT tray, due to a lot less heat transfer to the surrounding ambient air, were not taken in consideration.

### BRIEF DESCRIPTION OF SEVERAL VIEWS OF THE DRAWINGS

The description of the invention will become more apparent and the specification itself will be better understood by referring to the accompanying sheets, 1/2 and 2/2, of new invented 12/18VCT tray, as follows:

### SHEET 1/2

FIG. 1: Front View of 12/18VCT tray, showing the front embodiment structure arrangement of 12/18VCT tray with the height of vertical sides of 18 inches and width of 4 inches for cable space of 12/18VCT tray, including the part numbers.

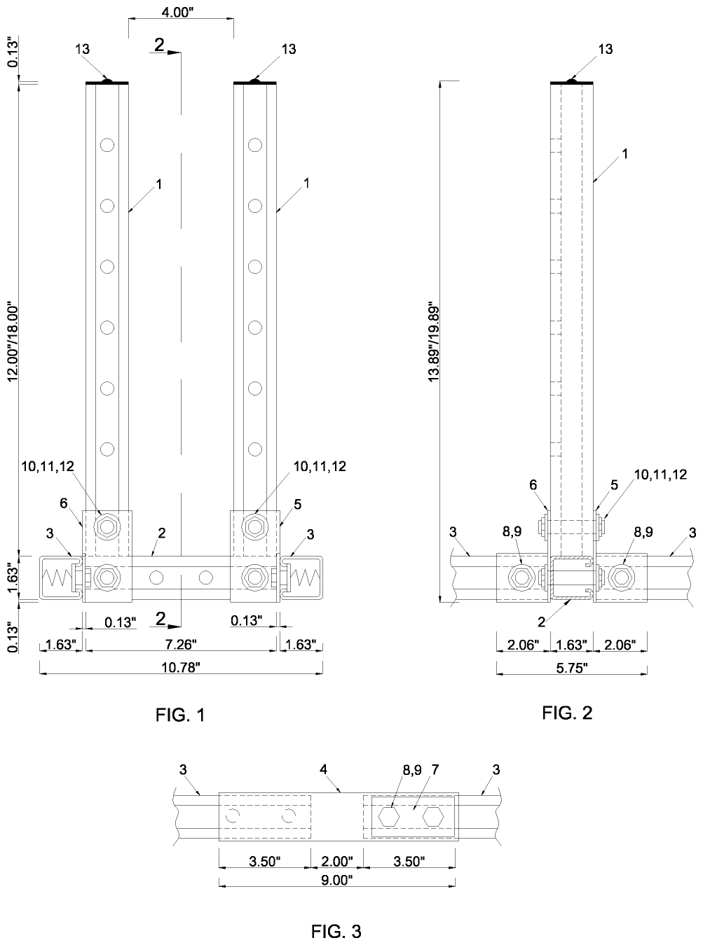

FIG. 2: Sectional View of 12/18VCT tray, showing the embodiment structure arrangement section of 12/18VCT tray with the overall height, of 19.89 inches, including the part numbers.

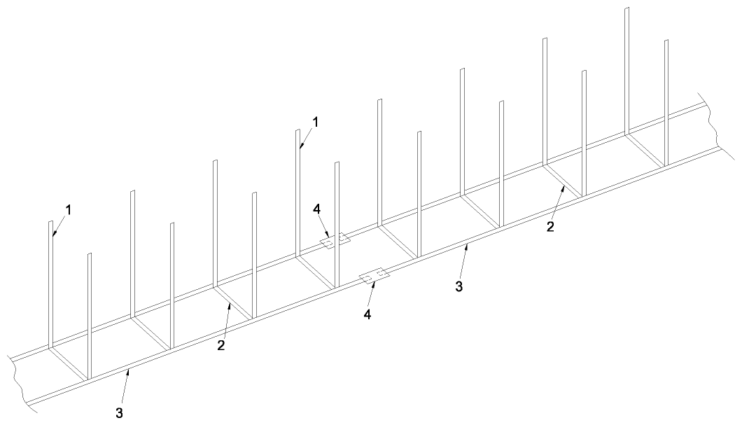

FIG. 3: Tray Splice between two 12/18VCT trays, showing the splice connection and the space, of 2 inches, between parts 3 of 12/18VCT trays installed in the same row line, including the part numbers.

### SHEET 2/2

General Arrangement View, of two 12/18VCT trays, graphically shown by two 12/18VCT trays, installed and spliced, on same row line, including the major part numbers

### DETAILED DESCRIPTION OF THE INVENTION

Embodiment Structural Built Arrangement and Part Numbers of 12/18VCT Tray

Part 1 is mounted in pairs every 12 inches, at each end of part 2 and at the side of each part 3, keeping 4 inches space between part 1 pairs. The total across width of 12/18VCT tray of 10.78 inches, as shown on sheet 1/2, FIG. 1.

Part 4 is mounted between two parts 3 of two 12/18VCT trays, installed on the same line, being inserted 3.50 inches into each end of parts 3 at both sides of 12/18VCT tray, as graphically as shown on sheet 2/2. Part 4 shall be tight down at only one end, using parts 7, 8 and 9, as shown on sheet 1/2, FIG. 3, living a space of 2 inches between parts 3, in order to ensure the extension and contraction mobility of 12/18VCT tray.

Part 5 and part 6 are mounted between parts 1, 2 and 3, one on the right and left sides of 12/18VCT tray, using parts 10, 11, 12, as shown on sheet 1/2, FIG. 2. The mounting total length of parts 2,5 and 6 is 5.75 inches, as shown on sheet 1/2, FIG. 2.

Part 13 is mounted on top of part 1, as shown on sheet 1/2, FIG. 1 and FIG. 2.

12/18VCT Tray Embodiment Structure Parts Weight Calculations:

### 12/18VCT Tray; Length Lt=120 in

B22: 1.92 lbs/ft (0.16 lbs/in), (Ref. 6, Pg. 20)
BTS22TH: 1.93 lbs/ft (0.16 lbs/in), (Ref. 6, Pg. 39)

### Part 1—Vertical Side Channel

Ht: 18 inch

### Channel: B22

### Qty: 20 EA

### Weight per EA: 18×0.16=2.88 lbs

### Subtotal Weight: 20×2.88=57.60 lbs

### Part 2—Horizontal Across Base

### Width: 7.76 in

### Channel: B22

### Qty: 10 EA

Weight per EA: 7.76×0.16 lbs/in=1.24 lbs

### Subtotal Weight: 10×1.24=12.42 lbs

### Part 3—Horizontal Long Base

### Length: 120 in

### Channel: B22

### Qty: 2 EA

### Weight per EA: 120×0.16=19.20 lbs

### Subtotal Weight: 2×19.20=38.40 lbs

### Part 4—Tray Splice

### Length: 9.00 in

### Channel: BTS22TH

### Qty: 2 EA

### Weight per EA: 9.00×0.16=1.44 lbs

### Subtotal Weight: 2×1.44=2.88 lbs

### Part 5—Three Hole (Right Hand) set Bent Angle Fitting B236R (Ref. 6, Pg. 78)

### Qty: 20 EA

### Weight per EA: 0.65 lbs

### Subtotal Weight: 20×0.65=13.00 lbs

### Part 6—Three Hole (Left Hand) set Bent Angle Fitting B236L (Ref. 6, Pg. 78)

### Qty: 20 EA

### Weight per EA: 0.65 lbs

### Subtotal Weight: 20×0.65=13.00 lbs

### Part 7—Two Hole Splice Plate B129 (Ref. 6, Pg. 73)

### Qty: 2 EA

### Weight per EA: 0.37 lbs EA

### Subtotal Weight: 2×0.37=0.74 lbs

Part 8—Hex Head Cap Screw—½ in×1 in HHCS (Ref. 6, Pg. 53)

### Qty: 44

### Weight per EA: 0.08 lbs

### Subtotal Weight: 44×0.08=3.52 lbs

### Part 9—Spring Nut N-B22-25-1 (Ref. 6, Pg. 47)

### Qty: 44

### Weight per EA: 0.12 lbs

### Subtotal Weight: 44×0.12=5.28 lbs

Part 10—All Tread Rod-ATR ½ in-13 (Ref. 6 Pg. 58)

### Qty: 40

### Weight per EA: 0.13 lbs

### Subtotal Weight: 40×0.13=5.20 lbs

### Part 11—Hex Nut ½ in HN (Ref. 6 Pg. 55)

### Qty: 80

### Weight per EA: 0.04 lbs

### Subtotal Weight: 80×0.04=3.20 lbs

### Part 12—Flat Washer ½ in FW (Ref. 6 Pg. 56)

### Qty: 80

### Weight per EA: 0.04 lbs

### Subtotal Weight: 80×0.04=3.20 lbs

### Part 13—End Cap B287 (Ref. 6 Pg. 110)

### Qty: 20

### Weight per EA: 0.13 lbs

### Subtotal Weight: 20×0.13=2.60 lbs

Total weight of 12/18VCT tray embodiment structure is as follows:
Ht=18 inch
Total weight: 57.60+12.42+38.40+2.88+13.0+13.0+0.74+3.52+5.28+5.20+3.20+3.20+2.60=161.04 lbs
Per linear foot: 161.04/10=16.10 lbs/ft

Qmax Heat Transfer, Per Square Foot, Calculations:

### Q=Hc×At×(Tc−Ta)

12/18VCT Tray; Ht=18 inch

### Left Vertical Side: Hc1=4.1 W/m²K (Ref. 8)

### Right Vertical Side: Hc2=4.1 W/m²K (Ref. 8)

Ht=18 in=0.456 m
Lt=12 in=0.305 m

### At=Ht×Lt=0.457×0.305=0.139 m²

### Tc−Ta=(75° C.−30° C.+273.15° K=318.15° K

### Q1=4.1×0.139×318.15=181.82 W (Ref. 7)

### Q2=4.1×0.139×318.15=181.82 W (Ref. 7)

### Qmax1=Q1+Q2=363.64 W

12/18HCT Tray; Wt=18 inch

### Top: Hc3=6.4 W/m²° C. (Ref. 8)

Wt=18 in=0.456 m
Lt=12 in=0.305 m

### At=Ht×Wt=0.456×0.305=0.139 m²

### Tc−Ta=(75° C.−30° C.)+273.15° K=318.15° K

### Qmax2=6.4×0.139×318.15=283.03 W (Ref. 7)

Multiplier k Calculations:

### (Qmax1−Qmax2)/Qmax2)+1=k

12/18VCT Tray; Ht=18 inch
((363.64−283.03)/283.03)+1=1.29

Number of Cables Nc Calculations:

### Cable #3/0 AWG Data: Ac=1.94 in² (Ref. 5, Pg. 16)

Cable 750 kCMIL Data: Dc=2.84 in (Ref. 5, Pg. 16)
12/18VCT Tray; Ht=18 inch

### Cable #3/0 AWG

### Formula: Ai=Aa×1.29

### Aa=21 in² (Ref. 2)

### Aa×1.29=Ai

21×1.29=27.09 in²

### Ai/Ac=Nc

### 27.09/1.94=13 Cables

Cable 750 kCMIL

### Wt/Dc=Nc

### 18/2.84=6 Cables (Ref. 3)

12/18HCT Tray; Wt=18 inch

### Cable #3/0 AWG

### Aa=21 in² (Ref. 2)

### Aa/Ac=Nc

### 21/1.94=10 Cables

Cable 750 kCMIL

### Wt/Dc=Nc

### 18/2.84=6 Cables (Ref. 3)

For Group #1, the number of cables Nc is increased to 13 cables for 12/18VCT tray, compared to 10 cables, for 12/18HCT tray. For Group #2 the number of cables Nc is equal to 6 cables for both 12/18VCT tray and 12/18HCT tray as well.

Increased Current Ii Calculations:

### Qa=Ia×V×t

### V=Ia×Rc

### V=Ia×Ia×Rc×t=Ia²×Rc×t

Qa=Ia²×1×1=Ia²

### Qmax=Qa×k=Ia²×k

Ii²=Ia²×k

### Ii=\sqrt{Ia²×k}=Ia\sqrt{k}

12/18VCT Tray; Ht=18 inch

### Ii=Ia×\sqrt{1.29}×=Ia×1.14

### Cable #3/0 AWG

### Ia=200 Amp (Ref. 1)

### Ii=200×1.14=228.0 Amp

750 kCMIL

### Ia=475 Amp (Ref. 1)

### Ii=475×1.14=541.50 Amp

Electrical Losses Lc1 and Lc2, Per Linear Foot, Calculations:

### Lc1=3×(Ia²×Rc)×Nc

### Lc2=3×(Ii²×Rc)×Nc

### Cable #3/0 AWG Rc=0.0797 Ohm/10³

Cable 750 kCMIL Rc=0.0176 Ohm/10³
12/18VCT Tray; Ht=18 inch

### Nc=13 Cables #3/0 AWG, Ia=200 Amps

Cable Losses: Lc1=3×(200²×0.0797/10³)×13=124.33 W
Nc=6 Cables 750 kCMIL, Ia=475 Amps
Cable Losses: Lc1=3×(475²×0.0176/10³)×6=71.48 W

### Nc=10 Cables #3/0 AWG, Ii=228 Amps

Cable Losses: Lc2=3×(228²×0.0797/10³)×10=124.29 W
Nc=6 Cables 750 kCMIL, Ii=541.50 Amps
Cable Losses: Lc2=3×(541.50²×0.0176/10³)×6=92.89 W

The electrical losses Lc1 of cables, supported by 12/18VCT tray, are less than Qmax1 for 12/18VCT; Lc1=124.33W<Qmax1=363.64 W.

The increased number of cables or the copper savings advantages will be obtained due to stronger capability of the natural convection heat transfer to surrounding ambient air, cooling faster the cable supported by 12/18VCT tray, compared to 12/18HCT tray.

Cable Weight Vertical Load Impact, against 12/18VCT Tray, Per Linear Foot, Calculations:

### Wc=Nc×Weight/ft

Cable Weight/ft of 3/C-#3/0 AWG: 2.66 lbs/ft (Ref. 5, Pg. 16)
Cable Weight/ft of 3/C-750 kCMIL: 9.60 lbs/ft (Ref. 5, Pg. 16)
12/18VCT Tray; Ht=18 inch
Group #1: 13-cables 3/C-#3/0 AWG, WC=13×2.66=34.58 lbs/ft
Group #2: 6-cables 3/C-750 kCMIL, WC=6×9.60=57.60 lbs/ft

Ice Load Impact Li (Ref. 5, Pg. 18) against 12/18VCT Tray, Per Linear Foot, Calculations:

It is considered that the ice builds-up on the following parts of 12/18VCT tray: two part 1, one part 2 and two part 3 for one foot long.

### Li=(2×Ht+1×7.26+2×Lt)/144×Di

Ice Max. Thickness: Ti=0.50 in
Ice Density: Di=57 lbs/ft³
12/18VCT Tray; Ht=18 inch

### 2×Ht=2×18 in, 1×7.26 in, 2×Lt=2×12 in

Li=(2×18+1×7.26+2×12)×0.5/144×57=13.31 lbs/ft

Snow Load Impact Si against 12/18VCT Tray (Ref. 5, Pg. 18), Per Linear Foot, Calculations:

Assume snow load impact Si (Ref. 5, Pg. 18) is equal to ice load impact Li, as follows:
12/18VCT Tray; Ht=18 inch
Si=13.31 lbs/ft

Concentrated Loads Impact We (Ref. 5, Pg. 18), Per Linear Foot, Calculations The concentrated load is a static load, against 12/18VCT tray, is considered to be 200 lbs at one point perpendicular to 12/18VCT tray top. The concentrated static load should be converted to on uniform load, per linear foot, as follows:

### We=2×Concentrated Static Load/Span Length

Tray span length Ss=10 ft. Cl=200 lbs
12/18VCT Tray; Ht=18 inch
We=2×x200/10=40 lbs/ft

The total of external vertical loads impact, per linear foot, including cable weight, ice and snow weights, concentrated load, and embodiment structure weight, against 12/18VCT tray, is less than the beam uniform load capacity per linear foot, of part 3, for a span of 120 inches of 12/18VCT tray:

12/18VCT Tray; Ht=18 inch
Total loads: 57.60+12.92+13.31+40+16.10=139.54 lbs/ft<340 lbs/ft

The total external horizontal loads impact, per linear foot, due to 120 mph wind, against 12/18VCT tray, with Htotal=13.85 inches and Htotal=19.85 inches, are less than the beam uniform load capacity of part 3 for a span of 120 inches, as follows:

P×Hoverall/12=VP lbs/ft (Ref. 5, Pg. 17)
P=36.80 lbs/ft²
12/18VCT Tray; Hoverall=19.89 inches
Total loads: 36.80×19.89/12=61.00 lbs/ft<340 lbs/ft

1-10. (canceled)

11. A vertical cable comprising:
twenty vertical sides part 1, ten on each side, of 18 inches height with 4 inches horizontal space between them, ten horizontal across base rungs part 2, of 7.26 inches underneath of the vertical sides, two horizontal long bases part 3, of 120 inches, one of each side of the horizontal across base rungs, twenty angle fittings R part 5, mounted on the right side of vertical sides part 1, twenty angle fittings L part 6, mounted on the left side of vertical sides to hold in place parts part 1, 2, and 3 with cap screws part 8, spring nuts part 9, tread rod part 10, hex nut part 11, flat washers part 12; and
vertical sides part 1 have on top the end cap part 13 to cover and protect each vertical side part 1.

12. The vertical cable of claim 11, further comprising:
joints the next vertical cable, installed in the same line path, using a splice, part 4 which is inserted 3.50 inches on part 3 of each vertical cable, being tide down on only one side by two hole splice plate, part 7, hex head cap screw, part 8 and spring nut, part 9;
a space of 2 inches is left between parts 3, in order to ensure the extension and contraction mobility of vertical cable embodiment structure due to temperature changes, as shown on Sheet 1/2, FIG. 3;
the embodiment structure of vertical cable assembly could run in horizontal or vertical paths, as required per applications and due to narrow embodiment structure and its vertical shape, the vertical cable of claim 11 is excellent application in crowded industrial or commercial areas where the horizontal space available is critical.

13. The vertical cable of claim 11, wherein the vertical cable could support electrical cables within the narrow space for cables created, of 4 inches width by 18 inches height, where the electrical cables can be loaded spreading vertically due to narrow space of 4 inches, up to 18 inches high, creating more exposure of electrical cables to the surrounding ambient air, on both vertical sides of vertical cable which will make a faster cooling of electrical cables;
due to faster cooling process of electrical cables in vertical cable tray two.
